(19) United States
(12) Patent Application Publication
(10) Pub. No.: US 2026/0280187 A1
(43) Pub. Date: Sep. 17, 2026

(54) CONNECTOR

(71) Applicant: SUMITOMO WIRING SYSTEMS, LTD., Mie (JP)

(72) Inventors: Hiromu KOIDE, Mie (JP); Yuichi OTO, Mie (JP)

(21) Appl. No.: 19/561,912

(22) Filed: Mar. 10, 2026

(30) Foreign Application Priority Data
Mar. 14, 2025 (JP) 2025-041221

(51) Int. Cl. H01R 13/631; H01R 12/72; H01R 12/77

(52) U.S. Cl. CPC H01R 13/631; H01R 12/722; H01R 12/771

(57) ABSTRACT

A connector includes a female connector and a male connector to be electrically connected to the female connector. The female connector includes a female terminal row, in which row, a plurality of female terminals are arrayed, and a female housing including female cavities for accommodating the female terminal row. The male connector includes a male terminal row, in which a plurality of male terminals are arrayed, and a male housing including a male cavity for accommodating the male terminal row. The male housing includes a finger hooking portion, on which a finger is hookable during an operation of connecting the male connector the female connector.

### CROSS-REFERENCE TO RELATED APPLICATIONS

This application is based on and claims priority from Japanese Patent Application No. 2025-041221, filed on March 14, 2025, with the Japan Patent Office, the disclosure of which is incorporated herein in its entirety by reference.

### TECHNICAL FIELD

The present invention relates to a connector.

### BACKGROUND

As described in Japanese Laid-open Publication No. 2022-039036, a connector used on a board is, for example, known.

### SUMMARY

In the connector as described above, it is required to improve operability in electrically connecting a male connector to a female connector.

The present disclosure aims to provide a connector capable of improving operability in electrically connecting a male connector to a female connector.

The present disclosure is directed to a connector with a female connector and a male connector to be electrically connected to the female connector, the female connector including a female terminal row, a plurality of female terminals being arrayed in the female terminal row, and a female housing including a female cavity for accommodating the female terminal row, the male connector including a male terminal row, a plurality of male terminals being arrayed in the male terminal row, and a male housing including a male cavity for accommodating the male terminal row, and the male housing including a finger hooking portion, a finger being hookable on the finger hooking portion during an operation of connecting the male connector to the female connector.

The connector of the present disclosure achieves an effect of being able to improve operability in electrically connecting the male connector to the female connector.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a connector of an embodiment.

FIG. 2 is a plan view showing the connector.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

[1] The connector of the present disclosure is provided with a female connector and a male connector to be electrically connected to the female connector, the female connector including a female terminal row, a plurality of female terminals being arrayed in the female terminal row, and a female housing including a female cavity for accommodating the female terminal row, the male connector including a male terminal row, a plurality of male terminals being arrayed in the male terminal row, and a male housing including a male cavity for accommodating the male terminal row, and the male housing including a finger hooking portion, a finger being hookable on the finger hooking portion during an operation of connecting the male connector to the female connector.

According to this configuration, a force for pushing the plurality of male terminals in the male connector into the plurality of female terminals in the female connector can be easily applied by hooking a finger on the finger hooking portion of the male connector and operating the male connector. In this way, operability in connecting the male connector to the female connector can be improved.

[2] In [1] described above, the finger hooking portion may include a finger hooking recess provided in at least one of a first principal surface and a second principal surface as both principal surfaces of the male housing. Operability in connecting the male connector to the female connector can be improved, for example, by such a finger hooking recess.

[3] In [1] described above, the female connector may include a receptacle for covering the female housing, and a peripheral wall of the male housing may be configured to be inserted between the receptacle and the female housing.

According to this configuration, the male connector can be easily inserted to a correct position in the female connector by inserting the peripheral wall of the male housing of the male connector between the receptacle and the female housing of the female connector. In this way, operability in connecting the male connector to the female connector can be further improved.

[4] In [3] described above, the receptacle may be provided to cover only a second principal surface, out of a first principal surface and the second principal surface as both principal surfaces of the female housing, and the first principal surface of the female housing may be exposed in the female connector.

According to this configuration, the female connector can be reduced in height as compared to the case where the female connector includes a receptacle for covering the both first and second principal surfaces of the female housing.

[5] In [4] described above, the finger hooking portion may include a finger hooking protrusion provided on only a first principal surface, out of the first principal surface and a second principal surface as both principal surfaces of the male housing, and the first principal surface of the male housing may be arranged on side of the first principal surface, out of the first principal surface and the second principal surface of the female housing.

According to this configuration, since the first principal surface of the female housing is exposed as described above, the finger hooking recess provided in the first principal surface of the male housing is not covered by the receptacle of the female connector. Therefore, operability in connecting the male connector to the female connector can be improved by the finger hooking recess and a height reduction can be realized with the male connector and the female connector connected.

[6] In any one of [3] to [5] described above, the receptacle may include a pair of side surface receptacles arranged to cover both side surfaces of the female housing, and inner surfaces of the pair of side surface receptacles may guide both side surfaces of the male housing during the operation of connecting the male connector to the female connector. According to this configuration, operability in connecting the male connector to the female connector can be further improved.

[7] In any one of [1] to [6] described above, the finger hooking portion may include a finger hooking protrusion projecting from at least one of both side parts of the male terminal. According to this configuration, operability in connecting the male connector to the female connector can be further improved.

[8] In any one of [1] to [7] described above, the female connector may be mounted on a board. According to this configuration, operability in connecting the male connector to the female connector mounted on the board can be improved.

### Details of Embodiment of Present Disclosure

A specific example of a connector of the present disclosure is described below with reference to the drawings. For the convenience of description, some components may be shown in an exaggerated or simplified manner in each drawing. Further, terms such as "first" and "second" in this specification are merely used to distinguish objects and do not rank the objects. An X axis, a Y axis and a Z axis orthogonal to each other are shown in each figure.

Hereinafter, one embodiment of a connector is described.

### Overall Configuration of Connector 10

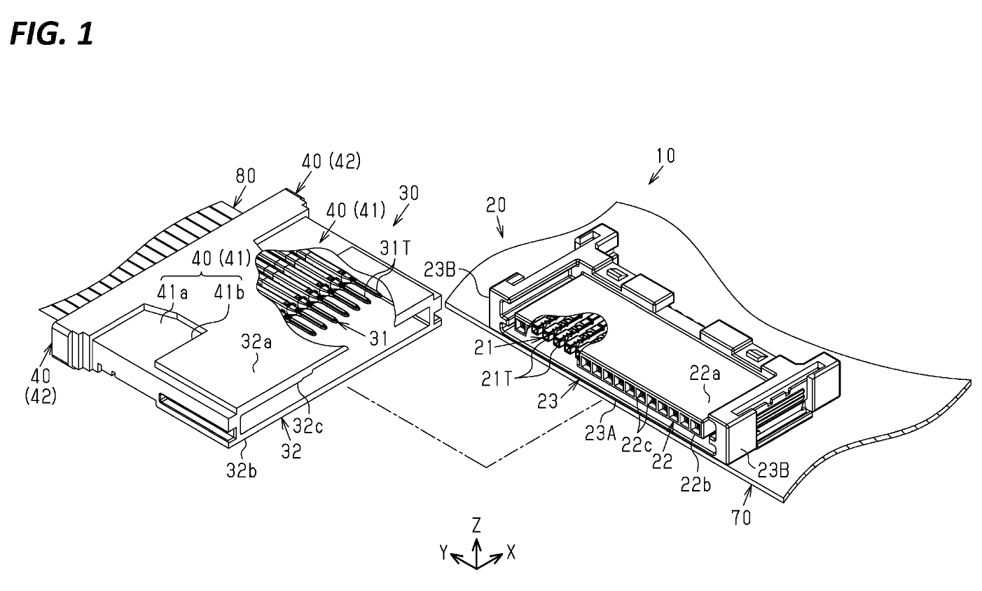

As shown in FIG. 1, a connector 10 is provided with a female connector 20 and a male connector 30 to be electrically connected to the female connector 20. The female connector 20 is, for example, mounted on a board 70. The board 70 is, for example, a circuit board. The board 70 may be a flexible board or a rigid board. The male connector 30 is, for example, connected to a circuit board 80 such as a flat cable.

### Configuration of Female Connector 20

The female connector 20 is provided with a female terminal row 21 and a female housing 22. The female terminal row 21 is configured by arraying a plurality of female terminals 21T.

The plurality of female terminals 21T are arrayed along the Y axis of FIG. 1. The female housing 22 includes female cavities 22c for accommodating the female terminal row 21. The number of the female cavities 22c corresponds to that of the plurality of female terminals 21T. That is, the female cavities 22c individually accommodate the female terminals 21T. A known configuration including a resilient piece made of metal can be adopted as the female terminal 21T.

The female housing 22 has a first principal surface 22a and a second principal surface 22b as both principal surfaces. In FIG. 1, a part of a wall portion having the first principal surface 22a of the female housing 22 is cut away and shown to make the female terminals 21T visible.

The first and second principal surfaces 22a, 22b of the female housing 22 extend along an XY plan of FIG. 1. The first and second principal surfaces 22a, 22b of the female housing 22 extend along an array direction of the plurality of female terminals 21T and a length direction of the female terminals 21T. A material of the female housing 22 is, for example, a synthetic resin.

The female connector 20 is provided with a receptacle 23 for covering the female housing 22. The receptacle 23 has a second principal surface receptacle 23A arranged to cover the second principal surface 22b of the female housing 22 and a pair of side surface receptacles 23B arranged to cover both side surfaces of the female housing 22. The pair of side surface receptacles 23B are coupled by the second principal surface receptacle 23A. A material of the receptacle 23 is, for example, a synthetic resin.

In the female connector 20, the receptacle 23 is provided to cover only the second principal surface 22b, out of the first and second principal surfaces 22a, 22b of the female housing 22. In the female connector 20, the first principal surface 22a of the female housing 22 is exposed.

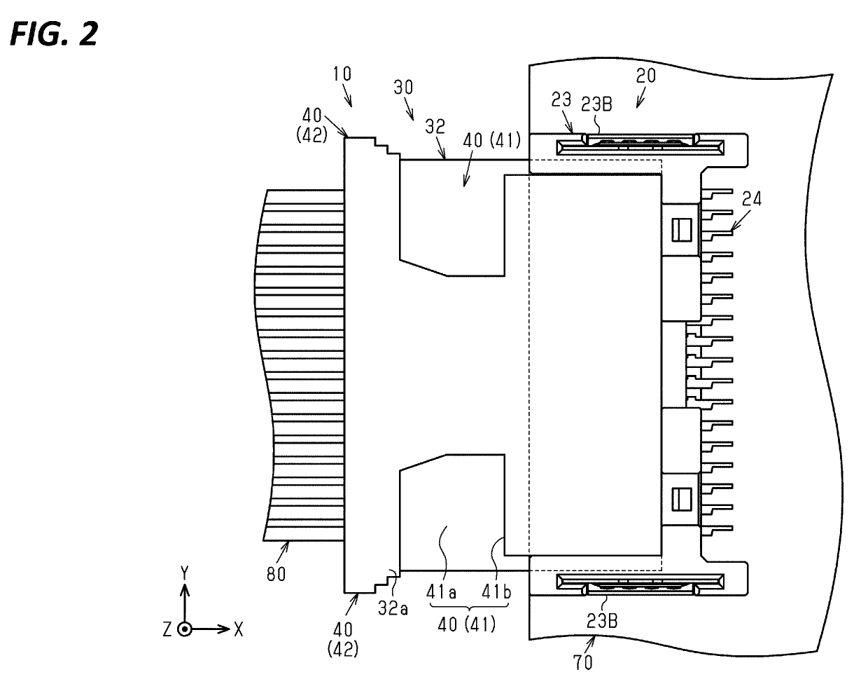

As shown in FIG. 2, the female connector 20 includes a board connection terminal row 24 to be connected to the board 70. The board connection terminal row 24 and the female terminal row 21 are electrically connected.

### Configuration of Male Connector 30

As shown in FIG. 1, the male connector 30 is provided with a male terminal row 31 and a male housing 32. The male terminal row 31 is configured by arraying a plurality of male terminals 31T. The plurality of male terminals 31T are arrayed along the X axis of FIG. 1. The male housing 32 includes a male cavity 32c for accommodating the male terminal row 31. The male cavity 32c collectively accommodates the male terminal row 31. A known configuration including a metal terminal, which can be pressed into contact with the resilient piece of the female terminal 21T, can be adopted as the male terminal 31T.

The male housing 32 has a first principal surface 32a and a second principal surface 32b as both principal surfaces. In FIG. 1, a part of a wall portion having the first principal surface 32a of the male housing 32 is cut away and shown to make the male terminals 31T visible.

The first and second principal surfaces 32a, 32b of the male housing 32 extend along an XY plan of FIG. 1. The first and second principal surfaces 32a, 32b of the male housing 32 extend along an array direction of the plurality of male terminals 31T and a length direction of the male terminals 31T. A material of the male housing 32 is, for example, a synthetic resin.

The male cavity 32c is so configured that the female housing 22 can be at least partially arranged. The wall portion having the first principal surface 32a of the male housing 32 is arranged to overlap the wall portion having the first principal surface 22a of the female housing 22. A wall portion having the second principal surface 32b of the male housing 32 is arranged to overlap a wall portion having the second principal surface 22b of the female housing 22. In other words, the female housing 22 can be arranged to be sandwiched between the wall portion having the first principal surface 32a of the male housing 32 and the wall portion having the second principal surface 32b of the male housing 32.

A peripheral wall of the male housing 32 is configured to be insertable between the receptacle 23 and the female housing 22 of the female connector 20. The wall portion having the second principal surface 32b of the male housing 32 is inserted between the second principal surface receptacle 23A of the female connector 20 and the second principal surface 22b of the female housing 22.

As shown in FIGS. 1 and 2, the male housing 32 includes a finger hooking portion 40, on which fingers can be hooked during an operation of connecting the male connector 30 to the female connector 20. The finger hooking portion 40 includes finger hooking recesses 41 provided in the first principal surface 32a of the male housing 32. The finger hooking recesses 41 are provided only in the first principal surface 32a, out of the first and second principal surfaces 32a, 32b of the male housing 32.

As shown in FIG. 2, there are, for example, a pair of the finger hooking recesses 41 provided apart in a width direction, which is a direction along the Y axis of the male housing 32. The pair of finger hooking recesses 41 are, for example, provided eccentrically on a base end side of the male housing 32. The base end side of the male housing 32 is an opposite side when an opening side of the male housing 32, into which the female housing 22 is inserted, is a tip side.

The finger hooking recess 41 has a bottom surface 41a and a wall surface 41b adjacent to the bottom surface 41a. The wall surface 41b of the finger hooking recess 41 includes a wall surface part located on the tip side with respect to the bottom surface 41a of the finger hooking recess 41 in a plan view shown in FIG. 2. As just described, a finger can be hooked to the wall surface part located on the tip side of the male housing 32 during the operation of connecting the male connector 30 to the female connector 20.

The wall surface 41b of the finger hooking recess 41 includes, for example, a wall surface part located on the base end side with respect to the bottom surface 41a of the finger hooking recess 41. A finger can be hooked to such a wall surface part located on the base end side of the male housing 32 when the male connector 30 is removed from the female connector 20.

In the wall surface 41b of the finger hooking recess 41, the wall surface part on the tip side and the wall surface on the base end side are preferably provided to extend in a direction intersecting the X axis. The wall surface 41b of the finger hooking recess 41 may have a discontinuous shape not surrounding a part of the bottom surface 41a or may be shaped to surround the entire periphery of the bottom surface 41a.

As shown in FIGS. 1 and 2, the finger hooking portion 40 includes a pair of finger hooking protrusions 42 projecting from both side parts of the male housing 32. The pair of finger hooking protrusions 42 are, for example, provided on the base end side of the male housing 32.

### Relationship of Side Surface Receptacles 23B of Female Connector and Male Housing 32

The inner surfaces of the pair of side surface receptacles 23B of the female connector 20 guide both side surfaces of the male housing 32 during the operation of connecting the male connector 30 to the female connector 20. The inner surfaces of the pair of side surface receptacles 23B and the both side surfaces of the male housing 32 have, for example, uneven structures extending along a connection direction of the male connector 30 to the female connector 20. The uneven structures of the inner surfaces of the pair of side surface receptacles 23B and those of the both side surfaces of the male housing 32 are engaged, thereby guiding the both side surfaces of the male housing 32.

### How to Use Connector 10

In connecting the male connector 30 and the female connector 20 of the connector 10, the male connector 30 is pressed against the female connector 20 to insert the female housing 22 into the male housing 32. For example, if the male connector 30 includes a locking structure for locking the female connector 20, the male connector 30 is inserted into the female connector 20 until locking is effected. In this way, each male terminal 31T of the male terminal row 31 is connected to each female terminal 21T of the female terminal row 21.

During the operation of connecting the male connector 30 to the female connector 20, i.e. when the male connector 30 is fit into the female connector 20, the male housing 32 can be operated by hooking fingers on the finger hooking portion 40 of the male housing 32. By such an operation of the male connector 30 utilizing the finger hooking portion 40, a force for pushing the plurality of male terminals 31T in the male connector 30 into the plurality of female terminals 21T in the female connector 20 can be easily applied.

In the above operation of the male connector 30, only the finger hooking protrusions 42 may be used or only the finger hooking recesses 41 may be used, out of the finger hooking portion 40. Further, in the above operation of the male connector 30, both the finger hooking recesses 41 and the finger hooking protrusions 42 may be used, out of the finger hooking portion 40. Further, the finger hooking portion 40 of the male connector 30 can be used, not only for the operation of the connecting the male connector 30 to the female connector 20, but also for an operation of removing the male connector 30 from the female connector 20.

### Functions and Effects of Embodiment

Functions and effects of this embodiment are described.

(1) The connector 10 is provided with the female connector 20 and the male connector 30 to be electrically connected to the female connector 20. The female connector 20 is provided with the female terminal row 21, in which the plurality of female terminals 21T are arrayed, and the female housing 22 including the female cavities 22c for accommodating the female terminal row 21. The male connector 30 is provided with the male terminal row 31, in which the plurality of male terminals 31T are arrayed, and the male housing 32 including the male cavity 32c for accommodating the male terminal row 31. The male housing 32 includes the finger hooking portion 40, on which fingers can be hooked during the operation of connecting the male connector 30 to the female connector 20.

According to this configuration, a force for pushing the plurality of male terminals 31T in the male connector 30 into the plurality of female terminals 21T in the female connector 20 can be easily applied by hooking fingers on the finger hooking portion 40 of the male connector 30 and operating the male connector 30. In this way, operability in connecting the male connector 30 to the female connector 20 can be improved.

(2) The finger hooking portion 40 includes the finger hooking recesses 41 provided in the first principal surface 32a of the male housing 32. For example, operability in connecting the male connector 30 to the female connector 20 can be improved by such finger hooking recesses 41.

(3) The female connector 20 is provided with the receptacle 23 for covering the female housing 22. The peripheral wall of the male housing 32 is configured to be inserted between the receptacle 23 and the female housing 22 of the female connector 20. In this case, the male connector 30 can be easily inserted to a correct position in the female connector 20 by inserting the peripheral wall of the male housing 32 of the male connector 30 between the receptacle 23 and the female housing 22 of the female connector 20. In this way, operability in connecting the male connector 30 to the female connector 20 can be further improved.

(4) The receptacle 23 of the female connector 20 is provided to cover only the second principal surface 22b, out of the first and second principal surfaces 22a, 22b as the both principal surfaces of the female housing 22. In the female connector 20, the first principal surface 22a of the female housing 22 is exposed. In this case, the female connector 20 can be reduced in height as compared to the case where the female connector 20 includes a receptacle for covering the both first and second principal surfaces 22a, 22b of the female housing 22. That is, in the female connector 20 in which the first principal surface 22a of the female housing 22 is exposed, a thickness as a dimension along a Z-axis direction of figures can be made smaller.

(5) The finger hooking portion 40 of the male connector 30 includes the finger hooking recesses 41 provided in only the first principal surface 32a, out of the first and second principal surfaces 32a, 32b as the both principal surfaces of the male housing 32. The first principal surface 32a of the male housing 32 is arranged on the side of the first principal surface 22a, out of the first and second principal surfaces 22a, 22b of the female housing 22.

In this case, since the first principal surface 22a of the female housing 22 is exposed as described above, the finger hooking recesses 41 provided in the first principal surface 32a of the male housing 32 are not covered by the receptacle 23 of the female connector 20. Therefore, operability in connecting the male connector 30 to the female connector 20 can be improved by the finger hooking recesses 41 and a height reduction can be realized with the male connector 30 and the female connector 20 connected. That is, with the male connector 30 and the female connector 20 connected, a thickness as a dimension along the Z-axis direction in figures can be made smaller.

(6) The receptacle 23 of the female connector 20 includes the pair of side surface receptacles 23B arranged to cover the both side surfaces of the female housing 22. The inner surfaces of the pair of side surface receptacles 23B guide the both side surfaces of the male housing 32 during the operation of connecting the male connector 30 to the female connector 20. In this case, operability in connecting the male connector 30 to the female connector 20 can be further improved.

(7) The finger hooking portion 40 of the male connector 30 includes the finger hooking protrusions 42 projecting from at least one of the both side parts of the male housing 32. In this case, operability in connecting the male connector 30 to the female connector 20 can be further improved.

(8) The female connector 20 can be used as a board connector to be mounted on the board 70. In this case, operability in connecting the male connector 30 to the female connector 20 mounted on the board 70 can be improved.

### Modifications

The above embodiment can be modified and carried out as follows. The above embodiment and the following modifications can be combined with each other and carried out without technically contradicting.

The number of the finger hooking recesses 41 of the male connector 30 may be one, three or more. For example, the male housing 32 may include one finger hooking recess 41 in a central part in a direction along the X axis in FIG. 1. Further, a plurality of finger hooking recesses 41 may be, for example, arrayed along the Y axis in FIG. 1.

The number of the finger hooking protrusions 42 of the male connector 30 may be one, three or more.

The finger hooking portion 40 may be composed of only the finger hooking recess(es) 41 or may be composed of only the finger hooking protrusion(s) 42.

The receptacle 23 of the female connector 20 may have a first principal surface receptacle for covering the first principal surface 22a. That is, the first principal surface 22a of the female housing 22 may not be exposed.

Although the receptacle 23 of the female connector 20 includes the side surface receptacles 23B and the second principal surface receptacle 23A, either the side surface receptacles 23B or the second principal surface receptacle 23A can be omitted. For example, in the case of omitting the second principal surface receptacle 23A, the configuration of the male housing 32 can be changed to include the finger hooking recesses 41 in the second principal surface 32b.

The entire receptacle 23 of the female connector 20 can be omitted.

The female connector 20 may include one female terminal row 21 or a plurality of female terminal rows arranged in parallel and the male connector 30 may include one male terminal row 31 or a plurality of male terminal rows arranged in parallel.

The female connector 20 can be used in various applications other than the use as the board connector to be mounted on the board 70. Further, the connector 10 can be, for example, used in various applications such as a power supply application and a signal transmission application.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising a female connector and a male connector to be electrically connected to the female connector,
the female connector including a female terminal row, a plurality of female terminals being arrayed in the female terminal row, and a female housing including a female cavity for accommodating the female terminal row,
the male connector including a male terminal row, a plurality of male terminals being arrayed in the male terminal row, and a male housing including a male cavity for accommodating the male terminal row, and
the male housing of the male connector including a finger hooking portion, a finger being hookable on the finger hooking portion during an operation of connecting the male connector to the female connector.

2. The connector of claim 1, wherein the finger hooking portion includes a finger hooking recess provided in at least one of a first principal surface and a second principal surface as both principal surfaces of the male housing.

3. The connector of claim 1, wherein:
the female connector includes a receptacle for covering the female housing, and
a peripheral wall of the male housing is configured to be inserted between the receptacle and the female housing.

4. The connector of claim 3, wherein:
the receptacle is provided to cover only a second principal surface, out of a first principal surface and the second principal surface as both principal surfaces of the female housing, and
the first principal surface of the female housing is exposed in the female connector.

5. The connector of claim 4, wherein:
the finger hooking portion includes a finger hooking protrusion provided on only a first principal surface, out of the first principal surface and a second principal surface as both principal surfaces of the male housing, and
the first principal surface of the male housing is arranged on side of the first principal surface, out of the first principal surface and the second principal surface of the female housing.

6. The connector of claim 3, wherein:
the receptacle includes a pair of side surface receptacles arranged to cover both side surfaces of the female housing, and
inner surfaces of the pair of side surface receptacles guide both side surfaces of the male housing during the operation of connecting the male connector to the female connector.

7. The connector of claim 1, wherein the finger hooking portion includes a finger hooking protrusion projecting from at least one of both side parts of the male terminal.

8. The connector of claim 1, wherein the female connector is mounted on a board.
